(19) United States
(12) Patent Application Publication
(10) Pub. No.: US 2015/0067704 A1
(43) Pub. Date: Mar. 5, 2015

(54) COMPUTATION DEVICE, COMPUTATION METHOD, AND COMPUTATION PROGRAM STORAGE MEDIUM

(71) Applicant: NEC CORPORATION, Tokyo (JP)

(72) Inventors: Takashi Takenaka, Tokyo (JP); Hiroaki Inoue, Tokyo (JP)

(21) Appl. No.: 14/385,339

(22) PCT Filed: Mar. 5, 2013
(86) PCT No.: PCT/JP2013/055989

§ 371 Date: Sep. 15, 2014

(30) Foreign Application Priority Data
Mar. 15, 2012 (JP) 2012-059262

(51) Int. Cl. G06F 9/54; G06F 9/46

(52) U.S. Cl. CPC G06F 9/542; G06F 9/466
USPC 719/318

(57) ABSTRACT

A computation device is provided with an event identification unit which receives a first event and outputs an event ID associated with an event type; a computation interim result retaining unit which receives the event ID and outputs a first computation interim result associated with the event ID; and a time-series computation processing unit which receives the first event and the first computation interim result, performs computation processing, and outputs a second event and a second computation interim result. The computation interim result retaining unit receives the second computation interim result, and retains the second computation interim result and the event ID in association with each other.

### TECHNICAL FIELD

The present invention relates to a computation device or the like, which is suitable for processing an event sequence, and more particularly to a computation device or the like for processing an event sequence in which events of multiple types are multiplexed.

### BACKGROUND ART

<Related Art 1: Hardware Configuration Method of Extracting an Event Sequence of a Predetermined Length and Performing Computation Processing for the Extracted Event Sequence>

Non Patent Literature 1 describes an example of related art directed to a computation device and a computation method for processing an event sequence. Non Patent Literature 1 discloses a hardware configuration method of extracting an event sequence of a predetermined length (also called as a “window”) from an input event sequence, and predetermined computation processing is performed for the extracted event sequence.

The technique of Non Patent Literature 1 is capable of configuring hardware of performing computation processing of counting the number of appearances of events, whose brand names each indicate a predetermined character string (“UBSN”, for example) from latest four events in an event sequence configured such that one event is formed by sets of four factors (serial number, brand name, price, and trading volume) (Q3 in Non Patent Literature 1).

The technique of Non Patent Literature 1 is also capable of configuring hardware of performing computation processing of extracting latest four event sequences whose brand names each indicate a predetermined character string (“UBSN”, for example) from an event sequence configured such that one event is formed by sets of four factors (serial number, brand name, price, and trading volume) (Q4 in Non Patent Literature 1), and calculating a weighted average of prices included in each of the four events (see FIG. 6 of Non Patent Literature 1).

<Related Art 2: Hardware Configuration Method of Detecting an Event Sequence Expressed by a Regular Expression of a Function and Performing Computation Processing for the Detected Event Sequence>

Non Patent Literature 2 describes an example of another related art directed to a computation device and a computation method for processing an event sequence. Non Patent Literature 2 discloses a hardware configuring method, in which an event sequence satisfying a predetermined regular expression is detected from an input event sequence, and predetermined computation processing is performed for the detected event sequence. FIG. 5 of Non Patent Literature 2 illustrates four configuration patterns for configuring a basic operator expressed by a regular expression into hardware.

The technique of Non Patent Literature 2 is capable of configuring hardware for performing computation processing of calculating a moving average of prices of four consecutive events from an event sequence configured such that one event is formed by sets of two factors (price and time) (see (a) of FIG. 6 of Non Patent Literature 2), and hardware for performing computation processing of detecting the limit (maximum or minimum) of the price (see (b) of FIG. 6 of Non Patent Literature 2).

<Other Related Arts>

Other related arts are disclosed in Patent Literatures 1 and 2, for instance.

### CITATION LIST

### Patent Literature

PTL 1: Japanese Laid-open Patent Publication No. Hei 05-081442
PTL 2: Japanese Laid-open Patent Publication No. Hei 04-054536

### Non Patent Literature

NPL 1: “Streams on Wires—A Query Compiler for FPGAs” by R. Mueller et al., Proceedings of Very Large Data Base Endowment, U.S., August 2009, Second Vol., issue 1, pp. 229-240
NPL 2: “20 Gbps C-Based Complex Event Processing” by Inoue et al., Proceedings of int'l Conf. on Field Programmable Logic and Applications, Greece, August 2011, pp. 97-102
NPL 3: “Complex Event Detection at Wire Speed with FPGAs” by L. Woods et al., Proceedings of Very Large Data Base Endowment, U.S., September 2010, Third Vol., issue 1-2, pp. 660-669
NPL 4: “FPGA Acceleration for the Frequent Item Problem” by R. Mueller et al., Proceedings 26th Int'l Conference on Data Engineering (ICDE), U.S., March 2010, pp. 669-680

### SUMMARY OF INVENTION

### Technical Problem

The problem of the related arts resides in the fact that it is not possible to efficiently configure hardware for performing concurrent processing of an event sequence in which events of multiple types are multiplexed. Concurrent processing of an event sequence in which events of multiple types are multiplexed is the processing as described below. Referring to FIG. 17, there is illustrated an example of an event sequence configured such that one event is formed by sets of four factors (serial number, brand name, price, and trading volume). In the event sequence illustrated in FIG. 17, it is regarded that a brand name is an event type, and events whose brand names are different from each other are events of different types. Then, the event sequence illustrated in FIG. 17 is regarded as an event sequence in which events of multiple types are multiplexed.

The technique of Non Patent Literature 1 is capable of performing predetermined computation processing of an event sequence of the same type. The technique is also capable of performing predetermined computation processing of an event sequence (hereinafter, called as a sub-event sequence for each event type), which is obtained by extracting events of the same type from a multiplexed event sequence. For instance, it is possible to configure hardware for performing computation processing of calculating a weighted average of prices of latest four events whose brand names each indicate a predetermined character string (“UBSN”, for example), from the multiplexed event sequence illustrated in FIG. 17.

On the other hand, concurrent processing of an event sequence in which events of multiple types are multiplexed is computation processing of extracting event sequences each of which includes the same brand name (hereinafter, called as sub-event sequences for individual brands) from the event sequence illustrated in FIG. 17, and calculating a weighted average of prices of four consecutive events in a sub-event sequence for individual brand, independently and concurrently for each brand.

Non Patent Literature 1 fails to disclose a hardware configuration method for efficiently performing concurrent processing of a multiplexed event sequence as described above. Therefore, when concurrent processing of a multiplexed event sequence as described above is performed by applying the technique of Non Patent Literature 1, as illustrated in FIG. 18, it is necessary to configure independent hardware for each brand. FIG. 18 illustrates a computation circuit for USBN, a computation circuit for GOOG, a computation circuit for WMH.L, and a computation circuit for BIDU, which perform concurrent processing.

For instance, Non-patent Literature 3 and Non-patent Literature 4 disclose an approach of configuring independent hardware for each event type. This is because in view of the necessity for performing predetermined computation processing to a plurality of events (in this example, four consecutive events), it is not possible to finish the computation processing each time an event arrives. Therefore, it is necessary to retain an interim result of computation processing all the time. Further, it is necessary to retain an interim result of computation processing for each brand in order to process an event of a certain brand which arrives during the computation processing of another brand.

However, there is considered a case, in which only one event arrives at one time in a multiplexed event sequence. In this case, when independent hardware for each brand is configured as illustrated in FIG. 18, only the hardware which performs computation processing corresponding to one brand is operated in response to arrival of one event. Further, the hardware independent of each other for each brand is hardware such that most parts thereof perform substantially the same processing as each other. Specifically, hardware is different from each other only in a part configured to extract an event of a target brand from a multiplexed event sequence. Each of the hardware commonly includes computation circuit for calculating a weighted average of prices with respect to four consecutive events in a sub-event sequence for each brand. Thus, a configuration method including many common parts that do not simultaneously operate is not efficient.

On the other hand, hardware resources mountable in a semiconductor circuit are limited. Therefore, applying an inefficient configuration method may increase the circuit scale, and may limit the number of brands processable by one semiconductor circuit.

In view of the above, an object of the present invention is to provide a computation device and a computation method for processing an event sequence in which events of multiple types are multiplexed.

### Solution to Problem

A computation device according to the invention includes:

an event identification unit receiving a first event and outputting an event ID associated with an event type;

a computation interim result retaining unit receiving the event ID, and outputting a first computation interim result associated with the event ID; and

a time-series computation processing unit receiving the first event and the first computation interim result, performing computation processing, and outputting a second event and a second computation interim result.

The computation interim result retaining unit receives the second computation interim result, and retains the second computation interim result and the event ID in association with each other.

A computation method according to the invention for use in a computation device is provided with an event identification unit, a computation interim result retaining unit, and a time-series computation processing unit. In the method:

the event identification unit receives a first event and outputs an event ID associated with an event type,

the computation interim result retaining unit receives the event ID and outputs a first computation interim result associated with the event ID,

the time-series computation processing unit receives the first event and the first computation interim result, performs computation processing, and outputs a second event and a second computation interim result, and

the computation interim result retaining unit receives the second computation interim result, and retains the second computation interim result and the event ID in association with each other.

A computation program according to the invention allows a computer to function as event identification unit, computation interim result retaining unit, and time-series computation processing unit. In the function:

the event identification unit receives a first event and outputs an event ID associated with an event type,

the computation interim result retaining unit receives the event ID and outputs a first computation interim result associated with the event ID,

the time-series computation processing unit receives the first event and the first computation interim result, performs computation processing, and outputs a second event and a second computation interim result, and

the computation interim result retaining unit receives the second computation interim result, and retains the second computation interim result and the event ID in association with each other.

### Advantageous Effects of Invention

According to the present invention, it is possible to provide a computation device or the like for processing an event sequence in which events of multiple types are multiplexed.

### BRIEF DESCRIPTION OF DRAWINGS

FIG. 1 is a block diagram illustrating the configuration of a first exemplary embodiment;

FIG. 2 is a block diagram illustrating the configuration of the first exemplary embodiment;

FIG. 3 is a block diagram illustrating the configuration of the first exemplary embodiment;

FIG. 4 is a block diagram illustrating the configuration of the first exemplary embodiment;

FIG. 5 is a block diagram illustrating the configuration of the first exemplary embodiment;

FIG. 6 is a flowchart illustrating an operation of the first exemplary embodiment;

FIG. 7 is a diagram illustrating a concrete example of the operation of the first exemplary embodiment;

FIG. 8 is a diagram illustrating a concrete example of the operation of the first exemplary embodiment;

FIG. 9 is a diagram illustrating a concrete example of the operation of the first exemplary embodiment;

FIG. 10 is a block diagram illustrating the configuration of a second exemplary embodiment;

FIG. 11 is a block diagram illustrating the configuration of the second exemplary embodiment;

FIG. 12 is a block diagram illustrating the configuration of the second exemplary embodiment;

FIG. 13 is a flowchart illustrating an operation of the second exemplary embodiment;

FIG. 14 is a diagram illustrating a concrete example of the operation of the second exemplary embodiment;

FIG. 15 is a diagram illustrating a concrete example of the operation of the second exemplary embodiment;

FIG. 16 is a diagram illustrating a concrete example of the operation of the second exemplary embodiment;

FIG. 17 is a diagram illustrating a concrete example of an event sequence in which events of multiple types are multiplexed; and

FIG. 18 is a block diagram illustrating an example of a computation device for processing an event sequence in which events of multiple types are multiplexed.

### DESCRIPTION OF EMBODIMENTS

In the following, embodiments for carrying out the present invention (hereinafter, called as “exemplary embodiments”) are described with reference to the accompanying drawings. The following exemplary embodiments are directed to predetermined computation processing of an event sequence in which events of multiple types are multiplexed. The present invention is adopted to a computation device or the like capable of implementing detection of complex events from an event sequence in which events of multiple types are multiplexed and computation defined in association with the detected event sequence.

In the following, there is described an event sequence in which events of multiple types are multiplexed. The computation devices in the exemplary embodiments perform predetermined processing on input events. The predetermined processing includes detection as to whether an event satisfies a predetermined condition, and predetermined computation using the event. The “event” means “various information or a set of information generated with occurrence of a certain phenomenon”. The predetermined detection is a detection as to whether information included in an event (hereinafter, called as “event information”) coincides with certain information, for instance. Alternatively, the predetermined detection is a detection as to whether the value of event information is not smaller (or not larger) than a certain threshold value, for instance. Further alternatively, the predetermined detection is a detection as to whether a plurality of event information items included in an event satisfy a predetermined relationship, for instance. The predetermined computation is computation using event information, for instance. Alternatively, the predetermined computation is computation with respect to event information and another information, for instance. Further, when a plurality of events are input in a time-series manner, in other words, when an event sequence is input, it is possible to define sequential processing of the respective events constituting an event sequence.

On the other hand, it is possible to classify one event by focusing on one or more event information items out of event information included in the event. This is called as event types. For instance, it is possible to classify one event on the basis of the value of predetermined event information. For instance, an event including four event information items (serial number, brand name, price, and trading volume) may be classified on the basis of the value of the brand name. Alternatively, an event may be classified as to whether the value of certain event information is included in a certain set. An event including four event information items (serial number, brand name, price, and trading volume) may be classified as to whether the brand name is included in a certain set (brands constituting the Nikkei stock average, for example).

When a plurality of events are input in a time-series manner, in other words, when an event sequence is input, it is possible to classify the respective events constituting the event sequence. Performing the classification makes it possible to constitute an event sequence obtained by extracting events of one type from an event sequence (hereinafter, called as a sub-event sequence for each event type), a plurality of events being input in a time-series manner to form the event sequence. An event sequence constituted of classifiable events as described above is called as an event sequence in which events of multiple types are multiplexed.

### First Exemplary Embodiment

### Configuration

The computation device of the first exemplary embodiment is configured to receive a data group (hereinafter, called as an event) including one or more data items (hereinafter, called as input data) as input, and to perform predetermined computation. Specifically, the computation device is configured to receive first events 1000 in a time-series manner, perform predetermined computation, and output second events 1100 in a time-series manner.

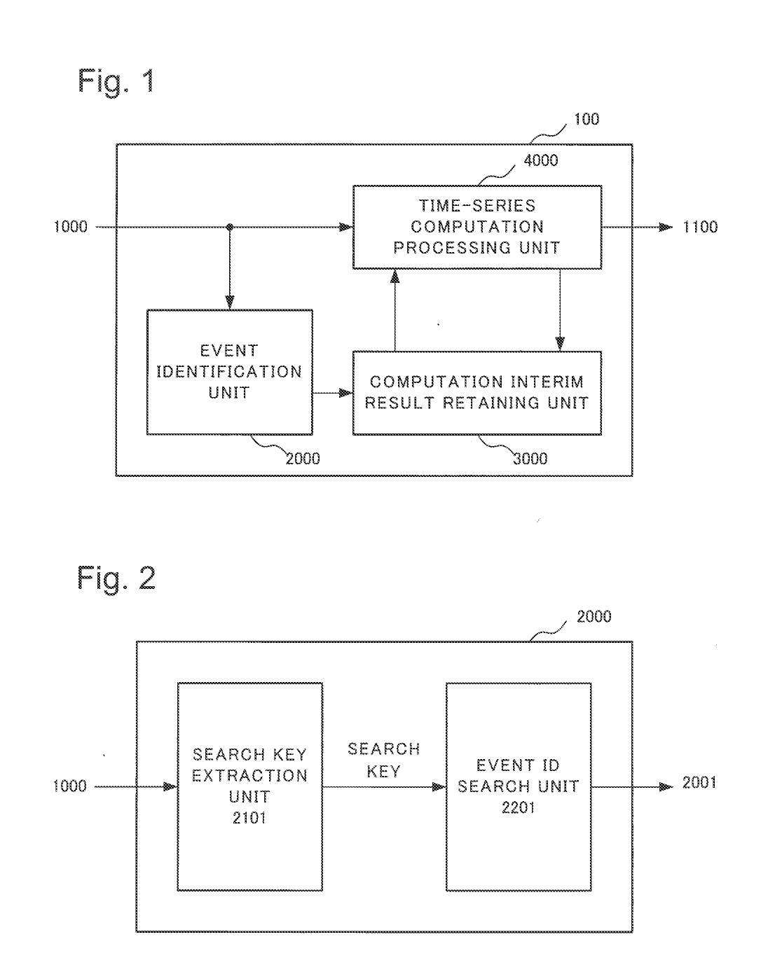

FIG. 1 is a diagram illustrating the computation device of the first exemplary embodiment. A computation device 100 of the first exemplary embodiment is provided with: an event identification unit 2000 which receives the first events 1000, and outputs an event ID associated with a type of each event; a computation interim result retaining unit 3000 which receives the event ID, and outputs a first computation interim result associated with the event ID; and a time-series computation processing unit 4000 which receives the first events 1000 and the first computation interim result, performs computation processing, and outputs the second event 1100 and a second computation interim result. The computation interim result retaining unit 3000 receives the second computation interim result, and retains the second computation interim result and the event ID in association with each other.

As illustrated in FIG. 1, the computation device 100 includes the event identification unit 2000 which identifies the type of the first event 1000, the computation interim result retaining unit 3000 which retains an interim result of time-series computation processing to be performed by the computation device 100 in association with the even type, and the time-series computation processing unit 4000 which performs predetermined time-series computation processing. Each of these units substantially operates as follows.

Events to be input to the computation device 100 are classified in advance on the basis of one or more event information items. This is called as event types. The event types are classified on the basis of the value(s) of one or more event information items, for instance. Further, for instance, the event types are classified on the basis as to whether the value(s) of one or more event information items is included in a predetermined set. Further, for instance, the event types are classified on the basis as to whether the values of a plurality of event information items are the same as each other. Further alternatively, the event types are classified on the basis of a time when events are input to the computation device 100. Furthermore, an identifier is associated with an event type (hereinafter, called as an event ID). A correlation between event types and event IDs is retained, in advance, in the event identification unit 2000.

The event identification unit 2000 identifies the type of the first event 1000 input to the computation device 100, and transmits the event ID associated with the event type to the computation interim result retaining unit 3000. An allocation mapping table is used for identifying the event type, for instance. The allocation mapping table is implemented by a memory, for instance, or is implemented by a register, for instance. Further, a CAM (Content Addressable Memory) is used for identifying the event type, for instance. Further, a search device based on a binary search tree is used for identifying the event type, for instance.

The computation interim result retaining unit 3000 retains, in advance, an interim result of immediately preceding computation processing in association with the event ID for each event type. The computation interim result retaining unit 3000 transmits, to the time-series computation processing unit 4000, a first computation processing interim result associated with the event ID transmitted from the event identification unit 2000.

The time-series computation processing unit 4000 receives the first event 1000. Further, the time-series computation processing unit 4000 receives the first computation processing interim result from the computation interim result retaining unit 3000. Furthermore, the time-series computation processing unit 4000 performs predetermined time-series computation processing on the basis of the first event 1000 and the first computation processing interim result. As the configuration of the time-series computation processing unit 4000, it is possible to use the technique of configuring a circuit for detecting an event sequence that satisfies a specific condition from multitudes of events, as described in Non Patent Literature 1, for instance. Alternatively, it is possible to use the technique of configuring hardware for performing “computation by a regular expression using a function as an element”, as described in Non Patent Literature 2.

The time-series computation processing unit 4000 generates the second event 1100 by predetermined time-series computation processing. The second event is output as a computation result of the computation device 100. Further, the time-series computation processing unit 4000 generates a second computation processing interim result by predetermined time-series computation processing. The second computation processing interim result is transmitted to the computation interim result retaining unit 3000.

The computation interim result retaining unit 3000 receives the second computation processing interim result from the time-series computation processing unit 4000, and retains the second computation processing interim result in association with the event ID.

FIG. 2 is a diagram illustrating the details of the event identification unit 2000 illustrated in FIG. 1. Referring to FIG. 2, the event identification unit 2000 includes a search key extraction unit 2101 and an event ID search unit 2201.

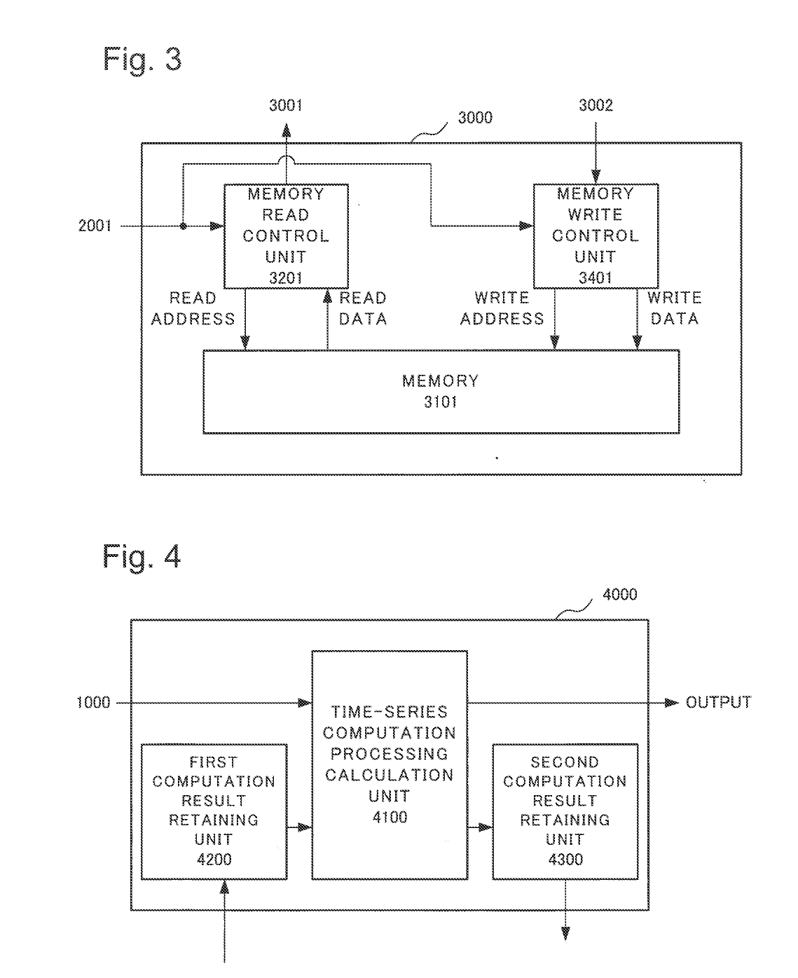

FIG. 3 is a diagram illustrating the details of the computation interim result retaining unit 3000 illustrated in FIG. 1. Referring to FIG. 3, the computation interim result retaining unit 3000 includes a memory 3101, a memory read control unit 3201, and a memory write control unit 3401.

FIG. 4 is a diagram illustrating the details of the time-series computation processing unit 4000 illustrated in FIG. 1. Referring to FIG. 4, the time-series computation processing unit 4000 includes a time-series computation processing calculation unit 4100, a first computation result retaining unit 4200, and a second computation result retaining unit 4300.

The first computation result retaining unit 4200 receives the first computation processing interim result from the computation interim result retaining unit 3000 and retains the first computation processing interim result.

The time-series computation processing calculation unit 4100 receives the first event. Further, the time-series computation processing calculation unit 4100 receives the first computation processing interim result from the computation result retaining unit 4200. Furthermore, the time-series computation processing calculation unit 4100 performs predetermined time-series computation processing on the basis of the first event and the first computation processing interim result, and generates the second event and the second computation processing interim result. The time-series computation processing calculation unit 4100 transmits the computation processing interim result to the second computation result retaining unit 4300.

The second computation result retaining unit 4300 receives the second computation processing interim result from the time-series computation processing calculation unit 4100, and transmits the second computation processing interim result to the computation interim result retaining unit 3000.

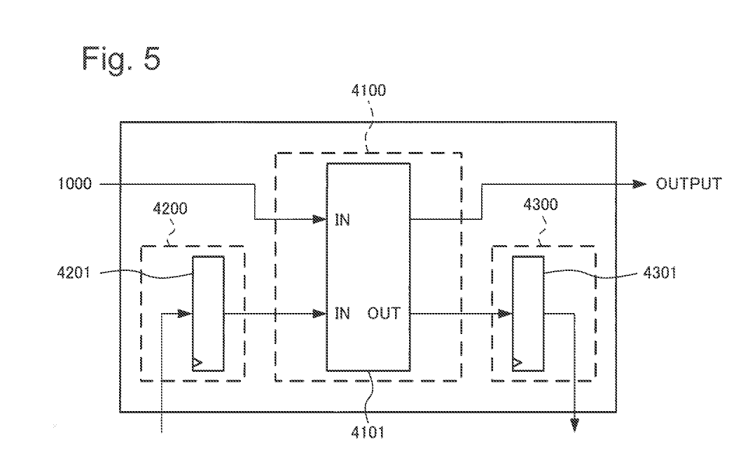

FIG. 5 is a diagram illustrating a concrete example of the time-series computation processing unit 4000 illustrated in FIG. 1. The first computation result retaining unit 4200 includes a register 4201, retains the first computation processing interim result transmitted from the computation interim result retaining unit 3000, and also transmits the first computation processing interim result to the time-series computation processing calculation unit 4100.

The time-series computation processing calculation unit 4100 includes a time-series computation processing calculation circuit 4101 which performs predetermined time-series computation processing, receives the event 1000 and the first computation processing interim result, performs predetermined time-series computation processing, and generates the second event and the second computation processing interim result.

The second computation result retaining unit 4300 includes a register 4201, retains the second computation processing interim result generated by the time-series computation processing calculation circuit 4101, and also transmits the computation processing interim result to the computation interim result retaining unit 3000.

### First Exemplary Embodiment

### Operation

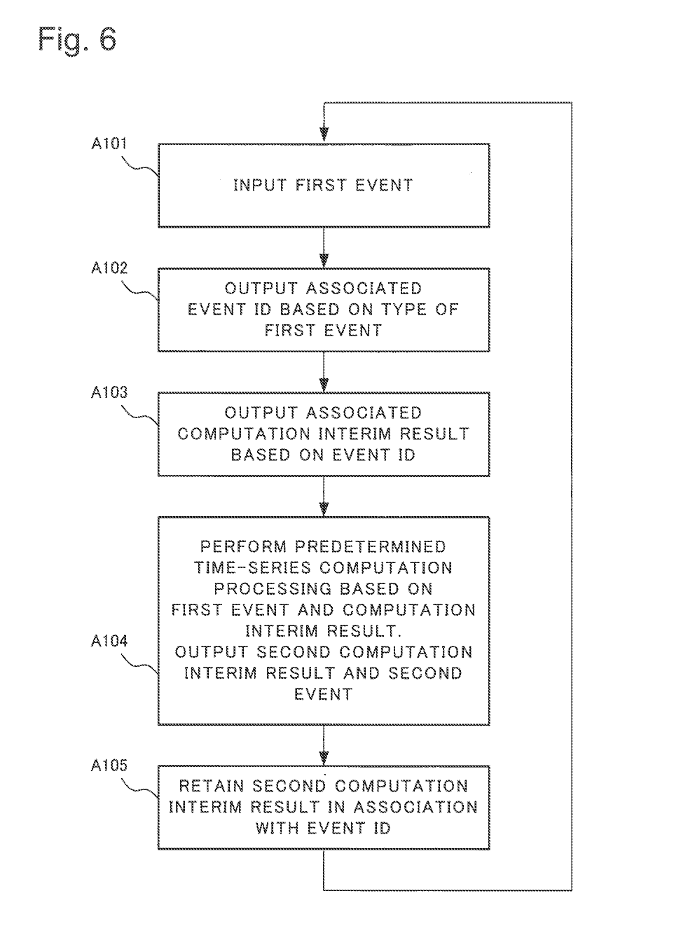

Next, an overall operation of the first exemplary embodiment is described in details referring to the block diagrams of FIG. 1 to FIG. 5 and the flowchart of FIG. 6.

First of all, as illustrated in FIG. 1, the first event 1000 including one or more input data items is input to the computation device 100 (Step A101 in FIG. 6).

Subsequently, the event identification unit 2000 in FIG. 1 identifies the type of the first event 1000, and outputs an event ID 2001 associated with the event type (Step A102 in FIG. 6).

Subsequently, the event identification unit 2000 transmits the event ID 2001 to the computation interim result retaining unit 3000. The computation interim result retaining unit 3000 selects a computation interim result associated with the event ID 2001 from among the computation interim results retained inside the computation interim result retaining unit 3000, and outputs the selected computation interim result as a first computation interim result 3001 (Step A103 in FIG. 6).

Subsequently, the computation interim result retaining unit 3000 transmits the first computation interim result 3001 to the time-series computation processing unit 4000. Further, the time-series computation processing unit 4000 receives the first event 1000. The time-series computation processing unit 4000 performs predetermined time-series computation processing on the basis of the first computation interim result 3001 and the first event 1000, and outputs the second event 1100 and a second computation interim result 3002. The second event 1100 is output to the outside as a computation result of the computation device 100 (Step A104 in FIG. 6).

Subsequently, the time-series computation processing unit 4000 transmits the second computation interim result 3002 to the computation interim result retaining unit 3000. The computation interim result retaining unit 3000 retains the second computation interim result 3002 inside the computation interim result retaining unit 3000, in association with the event ID 2001 (Step A105 in FIG. 6).

Lastly, the operation returns to Step A101 in FIG. 6, and starts processing of a newly input event.

### First Exemplary Embodiment

### Advantageous Effect

Next, an advantageous effect of the first exemplary embodiment is described. In the first exemplary embodiment, the computation device is provided with an event identification unit, a computation interim state retaining unit, and a time-series computation processing unit. The event identification unit is operated to receive a first event and output an event ID associated with the event type. The computation interim state retaining unit is operated to receive the event ID and output a first computation interim result associated with the event ID. The time-series computation processing unit is operated to receive the first event and the first computation interim result, perform predetermined computation processing, and output a second event and a second computation interim result. Further, the computation interim state retaining unit is operated to receive the second computation interim result and retain the second computation interim result in association with the event ID. Thus, it is possible to perform computation processing of an event sequence in which events of multiple types are multiplexed.

### First Exemplary Embodiment

### Computation Method and Computation Program

The computation method in the first exemplary embodiment is such that the operation of the computation device 100 in the first exemplary embodiment is regarded as a method invention. Specifically, the computation method in the first exemplary embodiment is a computation method to be used for the computation device 100 provided with the event identification unit 2000, the computation interim result retaining unit 3000, and the time-series computation processing unit 4000. The event identification unit 2000 receives the first events 1000 and outputs an event ID associated with each event type. The computation interim result retaining unit 3000 receives the event ID and outputs the first computation interim result associated with the event ID. The time-series computation processing unit 4000 receives the first event 1000 and the first computation interim result, performs computation processing, and outputs the second event 1100 and the second computation interim result. The computation interim result retaining unit 3000 receives the second computation interim result, and retains the second computation interim result and the event ID in association with each other.

The computation device 100 of the first exemplary embodiment may be implemented by software. The computation program of the first exemplary embodiment is configured to replace the respective elements of the computation device 100 in the first exemplary embodiment by respective function unit, and cause a computer to function as the respective unit. Specifically, the computation program of the first exemplary embodiment is a computation program which causes a computer to function as event identification unit (2000), computation interim result retaining unit (3000), and time-series computation processing unit (4000). The event identification unit (2000) receives the first events 1000 and outputs an event ID associated with each event type. The computation interim result retaining unit (3000) receives the event ID and outputs the first computation interim result associated with the event ID. The time-series computation processing unit (4000) receives the first event 1000 and the first computation interim result, performs computation processing, and outputs the second event 1100 and the second computation interim result. The computation interim result retaining unit (3000) receives the second computation interim result, and retains the second computation interim result and the event ID in association with each other. The computer may be a general computer constituted of a memory, a CPU, an input/output interface, and the like. The program is loaded in the memory, and read line by line by the CPU for interpretation and execution. Further, the program may be recorded in a non-transitory storage medium such as an optical disc or a semiconductor memory. In the above case, the program is read from the storage medium by the computer for execution.

### Second Exemplary Embodiment

### Configuration

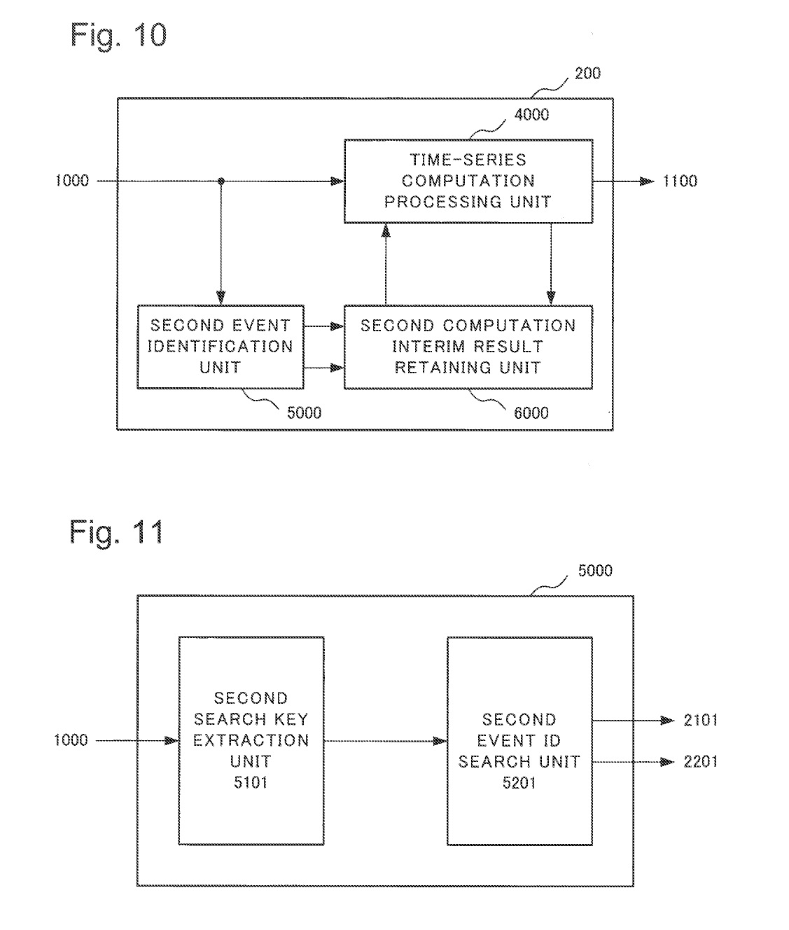

FIG. 10 is a diagram illustrating a computation device of the second exemplary embodiment. A computation device 200 of the second exemplary embodiment is provided with: an event identification unit 5000 which receives first events 1000, outputs a first event ID associated with each event type, newly generates a second event ID, outputs the second event ID, and retaining the event type and the second event ID in association with each other; a computation interim result retaining unit 6000 which receives the first event ID and outputs a first computation interim result associated with the first event ID; and a time-series computation processing unit 4000 which receives the first event 1000 and the first computation interim result, performs computation processing, and outputs a second event 1100 and a second computation interim result. The computation interim result retaining unit 6000 receives the second computation interim result and the second event ID, and retains the second computation interim result and the second event ID in association with each other.

The computation device 200 in FIG. 10 is different from the computation device 100 in FIG. 1 in a point that the second event identification unit 5000 is provided in place of the event identification unit 2000, and the second computation interim result retaining unit 6000 is provided in place of the computation interim result retaining unit 3000.

The second event identification unit 5000 in FIG. 10 identifies the event type, and transmits the first event ID stored in association with the event to the second computation interim result retaining unit 6000. Concurrently, the second event identification unit 5000 newly associates the second event ID with the event type, and retains the second event ID. Concurrently, the second event identification unit 5000 transmits the second event ID to the second computation interim result retaining unit 6000. The newly associated second event ID may be an event ID that is not associated with the types of other events, for instance. Further, for example, it is possible to re-use an event ID that is associated with the event type satisfying a predetermined condition among the types of other events. The predetermined condition may be, for example, an event type which does not arrive the computation device for a predetermined period of time.

FIG. 11 is a diagram illustrating the details of the second event identification unit 5000 illustrated in FIG. 10. Referring to FIG. 11, the second event identification unit 5000 is different from the event identification unit 2000 in FIG. 2 in a point that a second search key extraction unit 5101 is provided in place of the search key extraction unit 2101, and a second event ID search unit 5201 is provided in place of the event ID search unit 2201.

The second computation interim result retaining unit 6000 in FIG. 10 receives the first event ID and the second event ID respectively from the second event identification unit 5000. Further, the second computation interim result retaining unit 6000 transmits a computation processing interim result associated with the first event ID to the time-series computation processing unit 4000. Furthermore, the second computation interim result retaining unit 6000 retains the computation interim result transmitted from the time-series computation processing unit 4000 in association with the second event ID.

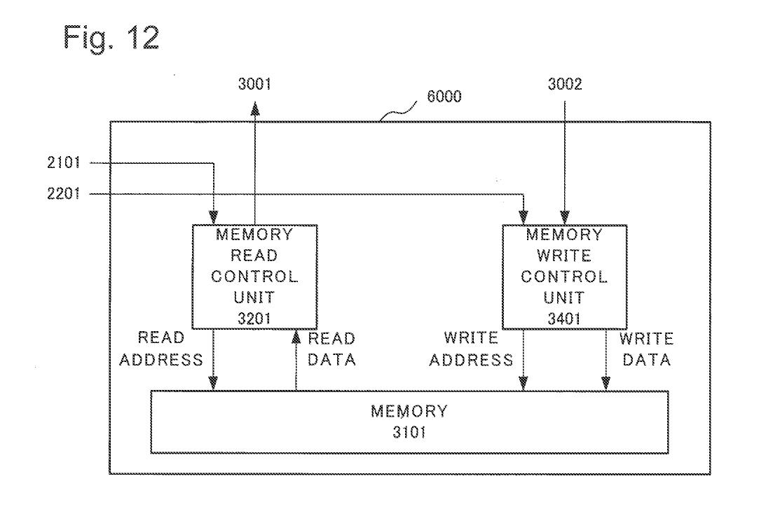

FIG. 12 is a diagram illustrating the details of the second computation interim result retaining unit 6000 illustrated in FIG. 10. Referring to FIG. 12, the second computation interim result retaining unit 6000 is different from the computation interim result retaining unit 3000 in FIG. 2 in the function of the memory write control unit 3401. In other words, the memory write control unit 3401 receives a second event ID 2201 in place of the event ID 2001, and writes, in a memory 3101, a second computation interim result 3002 and the second event ID 2201 received from the time-series computation processing unit 4000, in association with each other.

### Second Exemplary Embodiment

### Operation

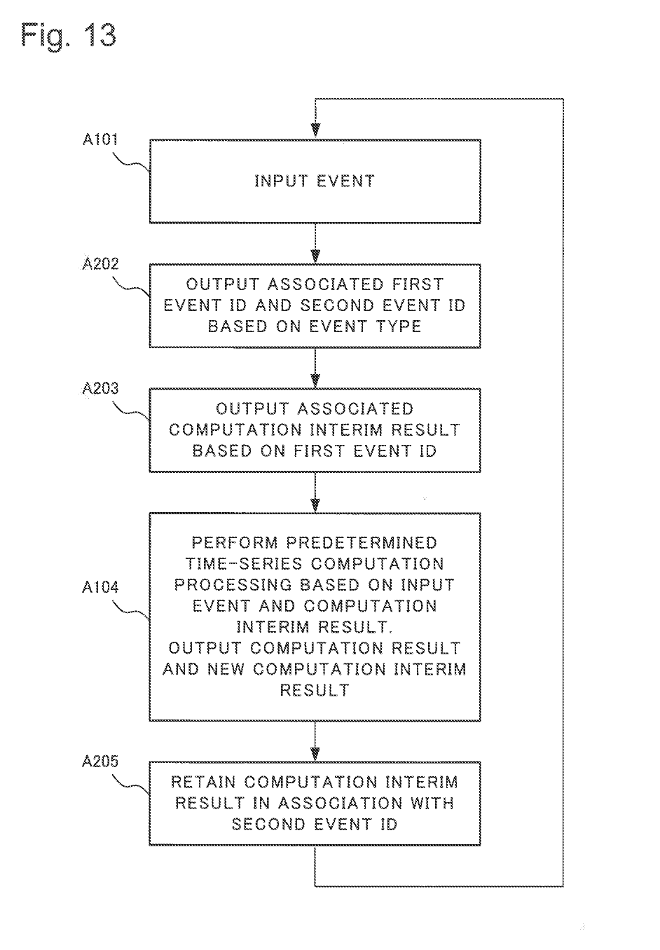

In the following, an overall operation of the exemplary embodiment is described in details referring to the block diagrams of FIG. 10 to FIG. 13 and the flowchart of FIG. 13. The flowchart of FIG. 13 is different from the flowchart of FIG. 6 in a point that Step A202 is provided in place of Step A102, Step A203 is provided in place of Step A103, and Step A205 is provided in place of Step A105.

At Step A202, the second event identification unit 5000 identifies the event type on the basis of the first event 1000, and outputs the first event ID 2101 associated with the event type. Concurrently, the second event identification unit 5000 newly generates and outputs the second event ID 2201. Further, the second event identification unit 5000 retains the second event ID 2201 in association with the event type.

At Step A203, the computation interim result retaining unit 6000 receives the first event ID 2101 and the second event ID 2201 from the event identification unit 5000. Further, the computation interim result retaining unit 6000 selects a first computation interim result 3001 associated with the first event ID 2101 from among the computation interim results retained inside the computation interim result retaining unit 6000. Further, the computation interim result retaining unit 6000 outputs the selected first computation interim result 3001 to the time-series computation processing unit 4000.

At Step A205, the computation interim result retaining unit 6000 receives the second computation interim result 3002 from the time-series computation processing unit 4000. Further, the computation interim result retaining unit 6000 retains the second computation interim result 3002 and the second event ID 2201 in association with each other.

### Second Exemplary Embodiment

### Advantageous Effect

Next, an advantageous effect of the second exemplary embodiment is described. The computation device of the second exemplary embodiment is provided with a second event identification unit, a second computation interim state retaining unit, and a time-series computation processing unit. The event identification unit is operated to receive a first event, output a first event ID associated with the event type and a second event ID which is newly generated with respect to the event, and also retain the second event ID in association with the event type. The second interim state retaining unit is operated to receive the first event ID, and output a first computation interim result associated with the event ID. The time-series computation processing unit is operated to receive the first event and the first computation interim result, perform predetermined computation processing, and output a second event and a second computation interim result. Further, the computation interim state retaining unit is operated to receive the second computation interim result, and retain the second computation interim result in association with the second event ID. Thus, it is possible to achieve computation processing of an event sequence in which events of multiple types are multiplexed.

Further, in the second exemplary embodiment, the second event identification unit is operated to newly assign the second event ID. Therefore, it is possible to associate the event ID, even when the event type which may be input to the computation device is unknown. Further, in the second exemplary embodiment, the second event identification unit is operated to newly assign the second event ID. Therefore, it is possible to associate an event ID with an event type, even when the number of types of events to be input to the computation device is larger than the number of event IDs.

### Second Exemplary Embodiment

### Computation Method and Computation Program

The computation method in the second exemplary embodiment is such that the operation of the computation device 100 of the second exemplary embodiment is regarded as a method invention. Specifically, the computation method in the second exemplary embodiment is a computation method for use in the computation device 200 provided with the event identification unit 5000, the computation interim result retaining unit 6000, and the time-series computation processing unit 4000. The event identification unit 5000 receives the first event 1000, outputs the first event ID associated with the event type, newly generates the second event ID, outputs the second event ID, and also retains the event type and the second event ID in association with each other. The computation interim result retaining unit 6000 receives the first event ID, and outputs the first computation interim result associated with the first event ID. The time-series computation processing unit 4000 receives the first event 1000 and the first computation interim result, performs computation processing, and outputs the second event 1100 and the second computation interim result. The computation interim result retaining unit 6000 receives the second computation interim result and the second event ID, and retains the second computation interim result and the second event ID in association with each other.

The computation device 200 of the first exemplary embodiment may be implemented by software. The computation program of the second exemplary embodiment is configured to replace the respective elements of the computation device 200 of the second exemplary embodiment by respective function unit, and cause the respective unit to be functioned by a computer. Specifically, the computation program of the first exemplary embodiment is a computation program which causes event identification unit (5000), computation interim result retaining unit (6000), and time-series computation processing unit (4000) to be functioned by a computer. The event identification unit (5000) receives the first event 1000, outputs the first event ID associated with the event type, newly generates the second event ID, outputs the second event ID, and also retains the event type and the second event ID in association with each other. The computation interim result retaining unit (6000) receives the first event ID, and outputs the first computation interim result associated with the first event ID. The time-series computation processing unit (4000) receives the first event 1000 and the first computation interim result, performs computation processing, and outputs the second event 1100 and the second computation interim result. The computation interim result retaining unit (6000) receives the second computation interim result and the second event ID, and retains the second computation interim result and the second event ID in association with each other. The computer may be a general computer constituted of a memory, a CPU, an input/output interface, and the like. The program is loaded in the memory, and read line by line by the CPU for interpretation and execution. Further, the program may be recorded in a non-transitory storage medium such as an optical disc or a semiconductor memory. In the above case, the program is read from the storage medium by the computer for execution.

In the following, operations of the first and second exemplary embodiments are described using concrete examples.

### First Example

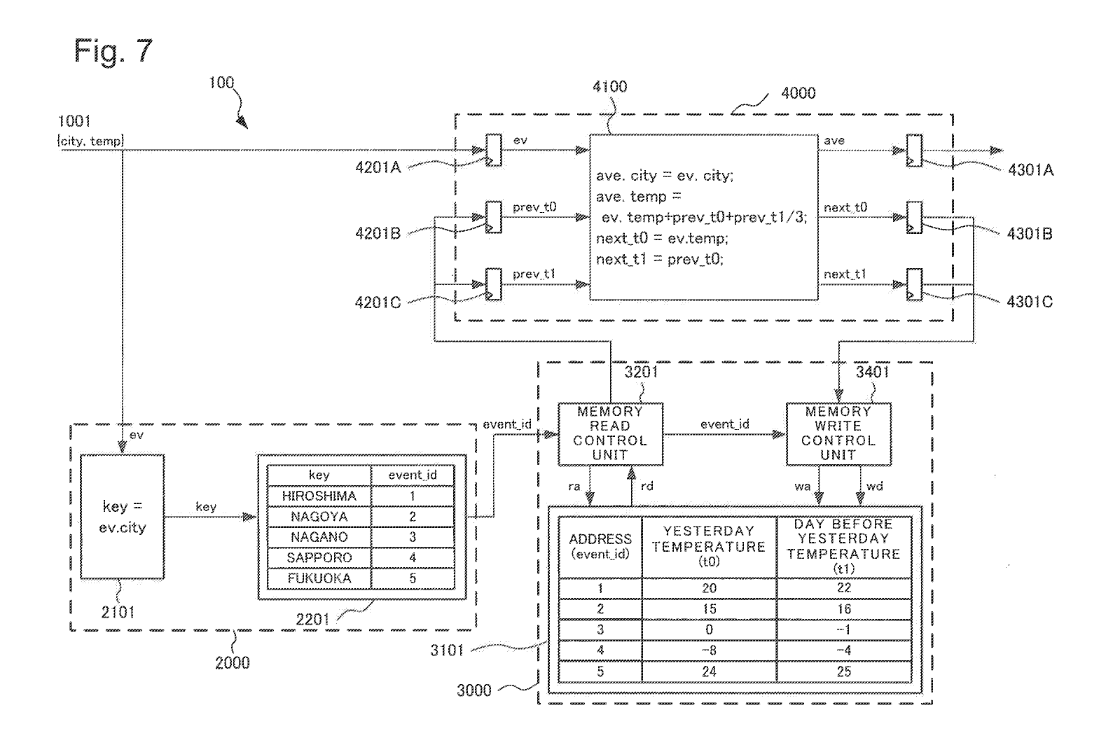

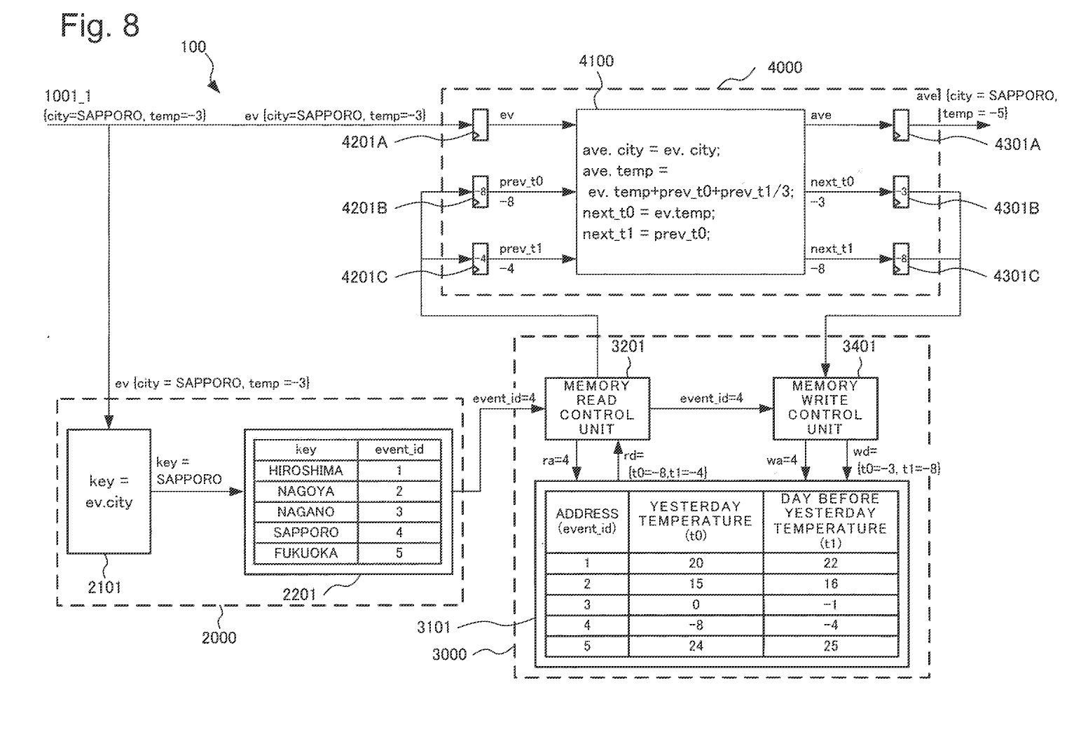

FIG. 7 illustrates a first example corresponding to the first exemplary embodiment. An event 1001 to be input to a computation device 100 of the first example includes, as event information, a city “city” and a temperature “temp”. In the example, events are classified on the basis of the value of the city “city”. Specifically, there is configured an event sequence in which events of multiple types are multiplexed. The computation device 100 in FIG. 7 is configured to receive the first event in a time-series manner, calculate an average temperature of each city for the last three days, and output a second event including event information relating to the city “city” and the average temperature “temp” in a time-series manner.

The event 1001 input to the computation device 100 is respectively transmitted to a search key extraction unit 2101 in an event identification unit 2000, and to a register 4201A in a time-series computation processing calculation unit 4100. The search key extraction unit 2101 in the event identification unit 2000 extracts the value of the city “city” in the event 1001 as a search key, and transmits the search key to an event ID search unit 2201.

The event ID search unit 2201 in the event identification unit 2000 retains, in advance, sets of a city “key” and an event ID “event_id”. Referring to FIG. 7, event IDs associated with HIROSHIMA, NAGOYA, NAGANO, SAPPORO, and FUKUOKA are indicated as 1, 2, 3, 4, and 5, respectively. The event ID search unit 2201 receives a search key “key” from the search key extraction unit 2101, and transmits the event ID associated with the search key to a memory read control unit 3201 in a computation interim result retaining unit 3000.

In a memory 3101 in the computation interim result retaining unit 3000, an event ID “event_id”, a yesterday temperature “t0”, and a day before yesterday temperature “t1” are stored in advance. Reading the value of the address indicated by the value of the event ID “event_id” from the memory 3101 makes it possible to respectively read the yesterday temperature “t0” and the day before yesterday temperature “t1” of each city. In the memory 3101 in FIG. 7, for instance, the yesterday temperature “t0”=20 and the day before yesterday temperature “t1”=22 are respectively stored as the value of the event ID “event_id”=1 (in the first address in the memory).

The memory read control unit 3201 in the computation interim result retaining unit 3000 receives the event ID “event_id” from the event ID search unit 2201, and reads the value of the address indicated by the value of the event ID “event_id”. Concurrently, the memory read control unit 3201 transmits the event ID “event_id” to a memory write control unit 3401. Further, the memory read control unit 3201 stores the yesterday temperature “t0” read from the memory in a register 4201B included in the time-series computation processing calculation unit 4100, and the day before yesterday temperature “t1” read from the memory in a register 4201C, respectively.

The time-series computation processing calculation unit 4100 in the time-series computation processing unit 4000 reads an event from the register 4201A, a first yesterday temperature “prev_t0” from the register 4201B, and a first day before yesterday temperature “prev_μl” from the register 4201C, respectively. Further, the time-series computation processing calculation unit 4100 extracts event information temperature “ev.temp” from an event “ev”, and calculates an average of the first yesterday temperature “prev_t0” and the first day before yesterday temperature “prev_μl”. The time-series computation processing calculation unit 4100 stores the calculated average value in an event information temperature “ave.temp” of a calculation result “ave”. Further, the time-series computation processing calculation unit 4100 extracts event information city “city” from the event “ev”, and stores the event information city “city” in event information “ave.city” of the calculation result “ave”. Further, the time-series computation processing calculation unit 4100 stores the calculation result “ave” in a register 4301A. Further, the time-series computation processing calculation unit 4100 stores the value of the event information temperature “ev.temp” of the event “ev” in a register 4301B as a second yesterday temperature “next_t0”. Further, the time-series computation processing calculation unit 4100 stores the first yesterday temperature “prev_t0” in a register 4301C as a second day before yesterday temperature “next_t1”.

The memory write control unit 3401 in the computation interim result retaining unit 3000 receives the event ID “event_id” from the memory read control unit 3201. Further, the memory write control unit 3401 reads the second yesterday temperature from the register 4301B, and the second day before yesterday temperature from the register 4301C, respectively. Further, the memory write control unit 3401 writes the second yesterday temperature and the second day before yesterday temperature in the address indicated by the event ID “event_id” in the memory 3101.

Operation 1 (event 1001_1 {city=SAPPORO, temp=−3})

Next, a method for processing an event sequence by the computation device in the first example is described. FIG. 8 is a diagram illustrating an example of an operation to be performed by the computation device configured to calculate an average temperature of each city for the last three days as illustrated in FIG. 7. FIG. 8 illustrates an example, in which an event 1001_1 with the city “city” being “SAPPORO” and the temperature “temp” being “−3” is given to the processing device as an input.

First of all, the event 1001_1 is respectively transmitted to the search key extraction unit 2101 in the event identification unit 2000 and to the register 4201A in the time-series computation processing unit 4000. The search key extraction unit 2101 extracts the value of the city “city” (SAPPORO) from the transmitted event 1001_1, and transmits the extracted value to the event ID search unit 2201 as a search key. The event ID search unit 2201 searches the value of the event ID “event_id” (4) on the basis of the value of the search key (SAPPORO), and transmits the event ID to the memory read control unit 3201 in the computation interim result retaining unit 3000.

The memory read control unit 3201 reads the first yesterday temperature “t0” and the first day before yesterday temperature “t1” from the fourth address in the memory 3101, on the basis of the value of the event ID “event_id” (4). The values read by this operation are {t0=−8, t1=−4}, respectively. The memory read control unit 3201 respectively stores the values in the register 4201B and in the register 4201C in the time-series computation processing unit 4000.

The time-series computation processing calculation unit 4100 respectively reads the values from the registers 4201A, 4201B, and 4201C; and performs predetermined computation. A second event with the city “city” being SAPPORO, and the temperature “temp” being “−5” is generated, and the second event is output as output data from the computation device 100. Further, the value of the second yesterday temperature “next_t0” (−3) is stored in the register 4301B, and the value of the second day before yesterday temperature “next_μl” (−8) is stored in the register 4301C.

The memory write control unit 3401 receives the event “event_id” from the memory read control unit 3201, and concurrently reads the second yesterday temperature and the second day before yesterday temperature from the registers 4301B and 4301C, respectively. Further, the memory write control unit 3401 stores the value of the second yesterday temperature (−3) and the value of the second day before yesterday temperature (−8) in the fourth address in the memory 3101, on the basis of the value of the event ID “event_id” (4).

Operation 2 (event 1001_2 {city=HIROSHIMA, temp=25})

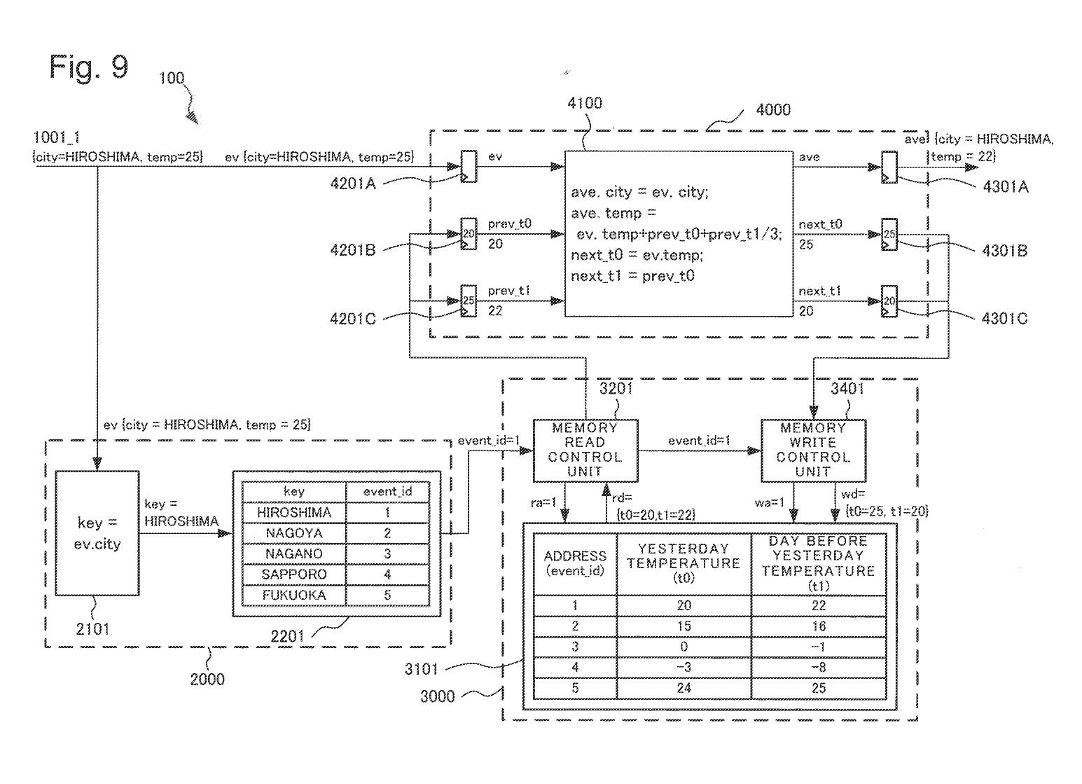

FIG. 9 is a diagram illustrating an example of an operation to be performed by the computation device configured to calculate an average temperature of each city for the last three days as illustrated in FIG. 7. FIG. 9 illustrates a state immediately after the operation in FIG. 8 is completed. As compared with FIG. 8, in FIG. 9, it is clear that the fourth address in the memory 3101 is updated to the value of the second yesterday temperature (−3) and the value of the second day before yesterday temperature (−8). Further, FIG. 9 illustrates an example, in which an event 1001_2 with the city “city” being HIROSHIMA and the temperature “temp” being 25 is given to the processing device as an input.

The event identification unit 2000 extracts a search key (HIROSHIMA) from the event 1001_2, acquires the value of the event ID “event_id” (1) on the basis of the search key, and transmits the acquired value to the computation interim result retaining unit 3000. The computation interim result retaining unit 3000 acquires the values of the first yesterday temperature and the first day before yesterday temperature {t0=20, t1=22}, on the basis of the value of the event ID “event_id” (1); and transmits the acquired values to the time-series computation processing unit 4000.

The time-series computation processing unit 4000 performs predetermined computation on the basis of the first event “ev”, the first yesterday temperature, and the first day before yesterday temperature; and generates the value of the second event “ave” {city=HIROSHIMA, temp=22}, the value of the second yesterday temperature (25), and the value of the second day before yesterday temperature (20). The second yesterday temperature and the second day before yesterday temperature are transmitted to the computation interim result retaining unit 3000. The computation interim result retaining unit 3000 respectively stores the value of the second yesterday temperature (25) and the value of the second day before yesterday temperature (20) in the first address in the memory 3101, on the basis of the value of the event ID “event_id” (1).

### Second Example

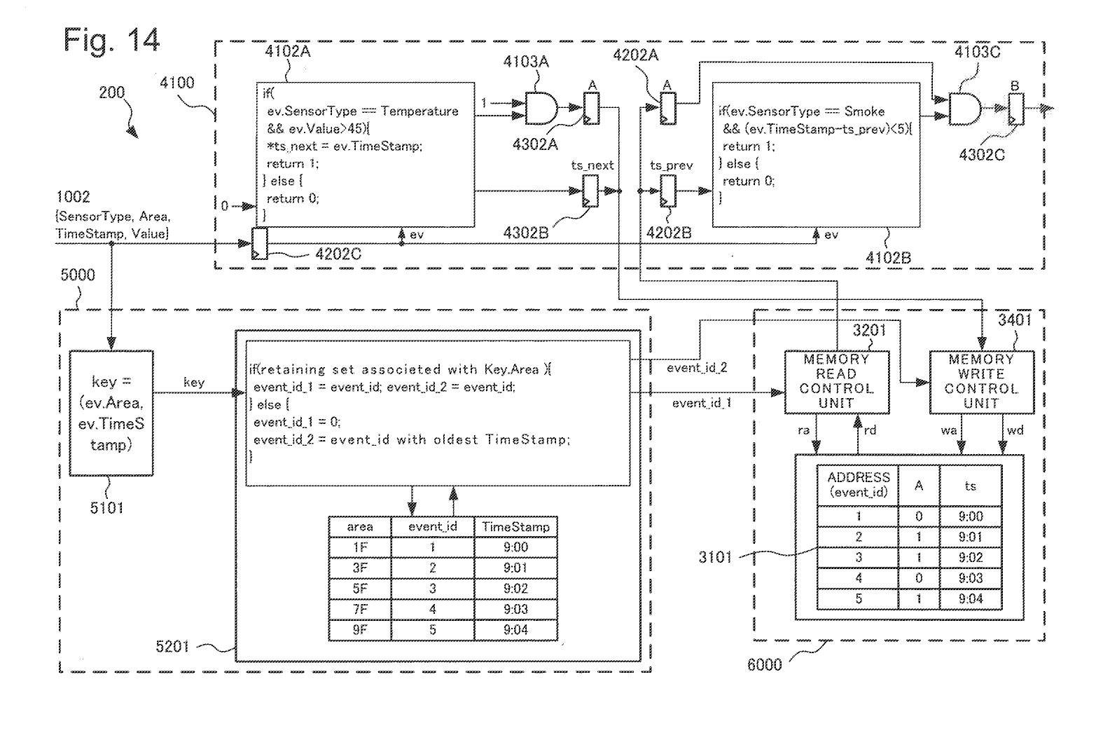

FIG. 14 illustrates a second example corresponding to the second exemplary embodiment. An event 1002 to be input to a computation device 200 in the second example includes, as event information, the type of a sensor “SensorType”, a location “Area”, a time “TimeStamp”, and a value “Value”. The sensor type “SensorType” includes values of two types, i.e., a temperature sensor “Temperature” and a smoke sensor “Smoke”. The value “Value” indicates a temperature value when the sensor type is the temperature sensor “Temperature”. Further, the value “Value” indicates the presence or absence of smoke when the sensor type is the smoke sensor “Smoke”. In the second example, events are classified on the basis of the value of the location “Area”. Specifically, there is formed an event sequence in which events including a sensor type, a sensor value, a time, and a value arrive in a time-series manner at each location, and the events of multiple types are multiplexed.

The computation device 200 in FIG. 14 is configured to receive an event in which events of multiple types are multiplexed as described above, and detect a target event sequence at each location “Area”. The target event sequence in the second example satisfies the following condition:

in a sub-event sequence obtained by classifying an event sequence on the basis of each location,

an event such that the value of the temperature sensor is 45 or higher arrives, and

an event such that the value of the smoke sensor is 1 subsequently arrives within five minutes thereafter.

This is one of the implementation examples, in which the processing device is configured to detect occurrence of fire with use of the temperature sensor and the smoke sensor, and detection of an event sequence such that “the temperature is 45° C. or higher” and “substantially concurrently, smoke is detected” is used as detection for occurrence of fire. Further, this is one of the implementation examples, in which the processing device is configured to detect abnormality of a device with use of the temperature sensor and the smoke sensor, and detection of an event sequence such that “the temperature is 45° C. or higher” and “substantially concurrently, smoke is detected” is used as detection for abnormality of the device.

The event 1002 input to the computation device 200 is transmitted to a search key extraction unit 2101 in an event identification unit 5000. The search key extraction unit 2101 in the event identification unit 5000 extracts the values of the location “Area” and time “TimeStamp” in the event 1002 as a search key, and transmits the search key to an event ID search unit 5201. The event ID search unit 5201 in the event identification unit 5000 retains, in advance, sets of a location “Area”, an event ID “event_id”, and a time “TimeStamp”.

Referring to FIG. 14, there is illustrated a case where the values of the location “Area” are 1F, 3F, 5F, 7F, and 9F; the respective values of the event ID associated with the values of the location are 1, 2, 3, 4, and 5; and the respective values of the time “TimeStamp” associated with the values of the location are 9:00, 9:01, 9:02, 9:03, and 9:04.

The event ID search unit 5201 receives a search key “key”={Area, TimeStamp} from the search key extraction unit 5101. Further, the event ID search unit 5201 searches the first event ID and the second event ID on the basis of the following rules. Rule 1: When there is a set whose value of “Area” in the “key” coincides within the retained “sets of a location “Area”, an event ID “event_id”, and a time “TimeStamp””, the values of “event_id” in the set are defined as the first event ID “event_id_{—}1” and the second event ID “event_id_{—}2”.

Rule 2: When there is no set whose value of “Area” in the “key” coincides within the retained “sets of a location “Area”, an event ID “event_id”, and a time “TimeStamp””, the value of the first event ID “event_id_{—}1” is set to “0”. Further, a set with the oldest “TimeStamp” value is selected from among the retained “sets of a location “Area”, an event ID “event_id”, and a time “TimeStamp””. Further, the value of the “event_id” in the selected set is defined as the second event ID “event_id_{—}2”. Then, the search key “key” and the second event ID are associated with each other to be retained by replacing the former set with the present set.

The event ID search unit 5201 transmits the searched first event ID “event_id_{—}1” and the searched second event ID “event_id_{—}2” to a second computation interim result retaining unit 6000. The second computation interim result retaining unit 6000 stores, in a memory 3101, in advance, an event ID and a computation interim result of a time-series computation processing calculation unit 4100 in association with each other. The computation interim result in the second example includes a determination result “A” such that an immediately preceding event is “an event whose value of the temperature sensor is 45 or higher”, and a value of the time of the event “ts”.

The memory 3101 respectively stores therein the immediately preceding event determination result “A”=0, and the event time “ts”=9:00, as the value of the first event ID “event_id”=1 (in the first address in the memory), for instance. Reading the value of the address indicated by the value of the first event ID “event_id_{—}1” allows for reading the value of the event determination result “A” and the value of the event time “ts”, respectively. The read values are transmitted to the time-series computation processing calculation unit 4100 as the first event determination result “A”, and the first event time.

The time-series computation processing calculation unit 4100 in FIG. 14 includes a time-series computation processing calculation unit 4102A for determining whether the input event is the event A such that “the value of the temperature sensor is 45 or higher”, and a time-series computation processing calculation unit 4102B for determining whether the input event is the event B such that “the event whose value of the smoke sensor is 1, and a time lag between the time of the immediately preceding event and the time of the target event is five minutes or less”. Further, the time-series computation processing calculation unit 4100 includes logic circuits 4103A and 4103B for determining whether the event A and the event B consecutively appear in a sub-event sequence obtained by classifying an event sequence for each event type. As the configuration of the logic circuits 4103A and 4103B, it is possible to utilize the hardware configuration method for performing “computation by a regular expression using a function as an element”, as described in Non-patent Literature 2, for instance.

The time-series computation processing calculation unit 4100 receives the first event, the first event determination result “A”, and the first event time “ts”; performs predetermined computation; and generates the second event, the second event determination result “A”, and the second event time “ts”. The second event is output as a computation result of the computation device 200. The second event determination result “A” and the second event time “ts” are transmitted to the second computation interim result retaining unit 6000.

The second computation interim result retaining unit 6000 receives the second event determination result “A” and the second event time “ts”, and retains the second event determination result “A” and the second event time “ts” in association with the second event ID. Specifically, the second computation interim result retaining unit 6000 writes the value of the second event determination result “A” and the value of the second event time “ts” in the memory 3101, while using the value of the second event ID “event_id_{—}2” as an address.

Operation 1 (event 1002_1 {SensorType=Smoke, Area=3F, TimeStamp=9:05, Value=1})

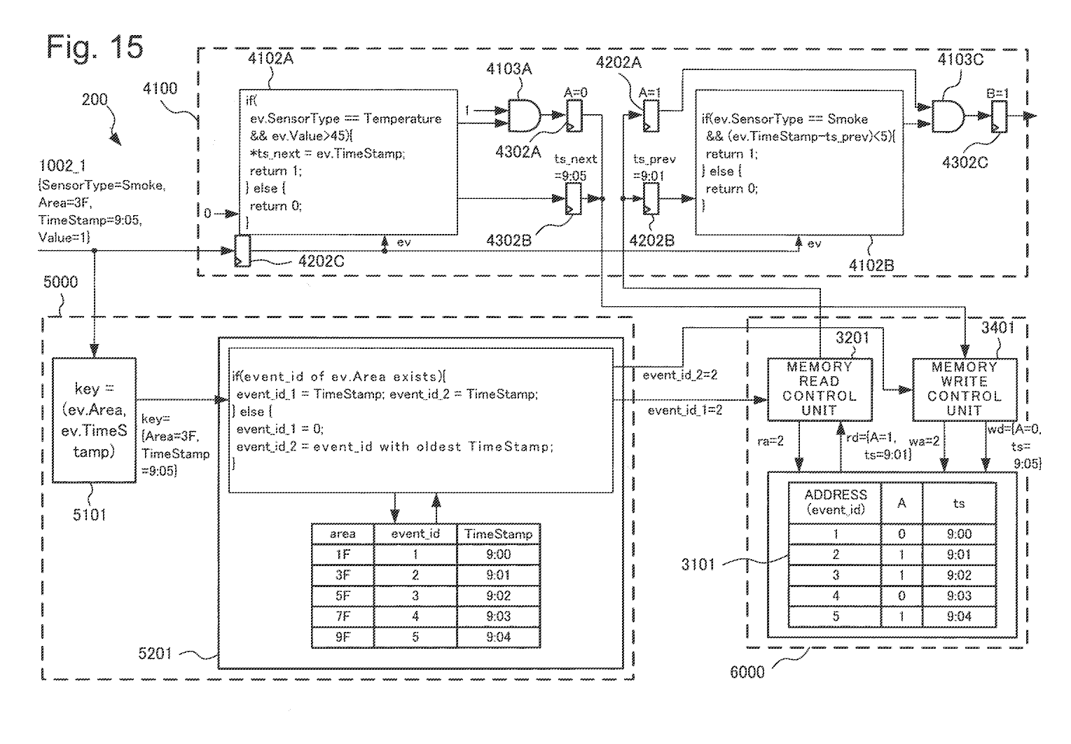

Next, a method for processing an event sequence by the computation device in the second example is described. FIG. 15 is a diagram illustrating an example of an operation to be performed by the computation device illustrated in FIG. 14. FIG. 15 illustrates an example, in which an event 1002_1 with the sensor type “SensorType” being smoke “Smoke”, the location “Area” being 3F, the time “TimeStamp” being 9:05, and the value “Value” being 1 is given to the processing device as an input.

First of all, the event 1002_1 is transmitted to the search key extraction unit 5101 in the event identification unit 5000. The search key extraction unit 5101 extracts the value of the location “Area” (3F) and the time (9:05) from the transmitted event 1002_1 as a search key “key”, and transmits the search key to the second event ID search unit 5201.

The second event ID search unit 5201 searches a set whose location “Area” coincides with the value of the search key ((Area=3F, TimeStamp=9:05)), on the basis of a predetermined procedure. The second event ID search unit 5201 retains, in advance, a set whose value of the location “Area” is 3F. Therefore, the second event ID search unit 5201 acquires the value of the event ID “event_id” (2) in the set. The second event ID search unit 5201 defines the acquired value of the event ID “event_id” as the values of the first event ID “event_id_{—}1” and the second event ID “event_id_{—}2”. Further, the acquired first event ID and the acquired second event ID are transmitted to the second computation interim result retaining unit 6000.

A memory read control unit 3201 in the second computation interim result retaining unit 6000 receives the first event ID “event_id_{—}1”, and respectively reads the value of the event determination result “A” (1) and the value of the event time “ts” (9:01) from the second address in the memory 3101, on the basis of the value of the first event ID “event_id l” (2). Further, the read values are transmitted to the time-series computation processing calculation unit 4100 as the first event determination result “A” and the first event time. The transmitted values of the first event determination result “A” and the first event time “ts” are stored in the register 4202A and register 4202B, respectively.

The time-series computation processing calculation unit 4100 in the time-series computation processing unit 4000 respectively reads the values from the registers 4202A, 4202B, and 4202C, and performs predetermined computation. The time-series computation processing calculation unit 4102A for determining whether the input event is the event A such that “the value of the temperature sensor is 45 or higher” stores the value “0” of the event determination result “A” in a register 4302A, because the sensor type “SensorType” of the event 1002_1 read from the register 4202C is the smoke sensor “Smoke”. Concurrently, the time-series computation processing calculation unit 4102A stores the value “9:05” of the time “TimeStamp” of the event 1002_1 in a register 4302B.

The time-series computation processing calculation unit 4102B determines whether the input event is the event B such that “the event whose value of the smoke sensor is 1, and a time lag between the time of the immediately preceding event and the time of the target event is five minutes or less”. The time-series computation processing calculation unit 4102B determines that the input event is the event B, because the sensor type “SensorType” of the event 1002_1 read from the register 4202C is the smoke sensor “Smoke”, the value “Value” is 1, and a time lag between the time of the immediately preceding event “9:01” read from the register 4202B and the time of the event 1002_1 “9:05” is within five minutes. Further, the value of the immediately preceding event determination result “A” read from the register 4202A is 1, and the value of the determination result “B” of the event B to be output from the time-series computation processing calculation unit 4102B is 1. Therefore, the time-series computation processing calculation unit 4102B determines that the events A and B consecutively appear in an event sequence constituted of an event whose value of the location “Area” is 3F, and stores the resultant value “1” in a register 4302C.

A memory write control unit 3401 in the second computation interim result retaining unit 6000 receives the second event ID “event_id_{—}2” from the second event ID search unit 5201, and concurrently reads the second event determination result “A” and the second event time “ts” from the registers 4302A and 4302B, respectively. Further, the memory write control unit 3401 stores the value of the second event determination result (0) and the value of the second event time (9:05) in the second address in the memory 3101, on the basis of the value of the second event ID “event_id_{—}2” (2).

Lastly, the value “1” stored in the register 4302C is output as the second event, which is an output from the computation device 200. Specifically, occurrence of fire is detected, for instance. Alternatively, abnormality of a device is detected, for instance.

Operation 2 (event 1002_2 (SensorType=Temperature, Area=2F, TimeStamp=9:07, Value=50))

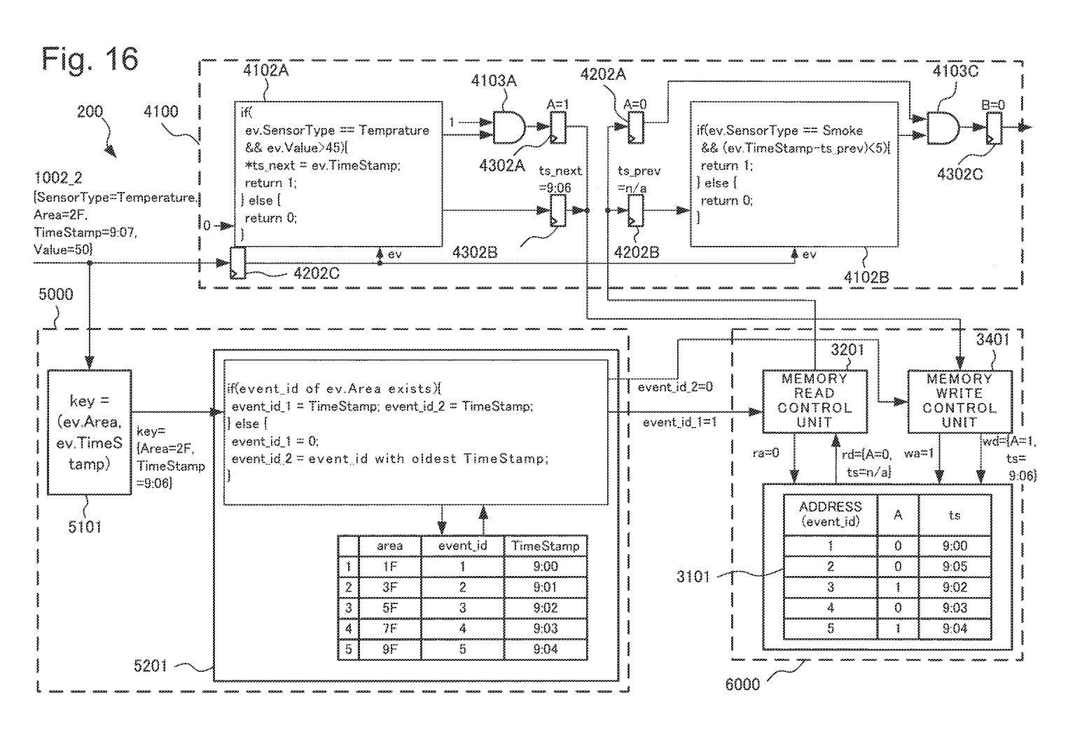

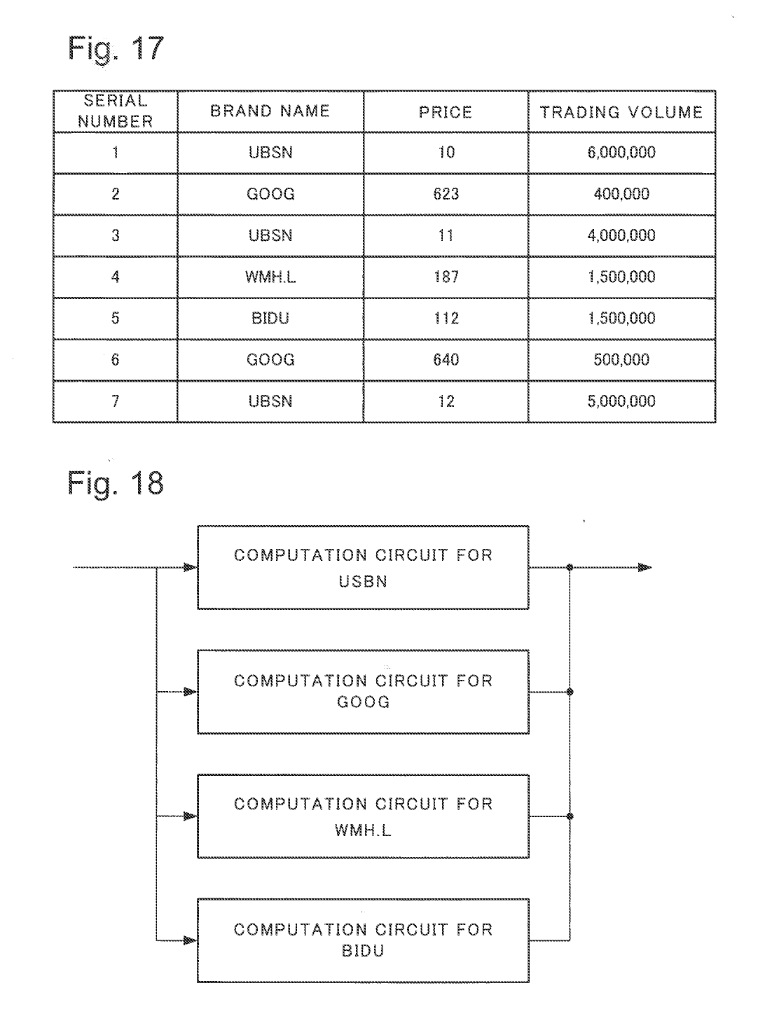

FIG. 16 is a diagram illustrating an example of an operation to be performed by the computation device illustrated in FIG. 14. FIG. 16 illustrates a state immediately after the operation in FIG. 15 is completed. As compared with FIG. 15, in FIG. 16, it is clear that the second address in the memory 3101 is updated to the value of the second event determination result (0) and the value of the second event time (9:05). Further, FIG. 16 illustrates an example, in which an event 1002_2 with the sensor type “SensorType” being the temperature “Temperature”, the location “Area” being 2F, the time “TimeStamp” being 9:07, and the value “Value” being 50 is given to the processing device as an input.

The second event identification unit 5000 extracts the search key ({Area=2F, TimeStamp=9:07}) from the event 1002_2. Then, the second event identification unit 5000 searches a set whose location “Area” coincides with a value based on the search key according to a predetermined procedure. The second event identification unit 5000 does not retain a set whose value of the location “Area” is “2F”. Therefore, the second event identification unit 5000 sets the value of the first event ID “event_id_{—}1” to “0”. Further, the second event identification unit 5000 sets the value of the event ID “event_id” (1) in the set whose time “TimeStamp” is the oldest among the retained sets (first row), as the value of the second event ID. Then, the search key “key”={Area=2F, TimeStamp=9:07} and the value of the second event ID (1) are associated with each other, and are retained by replacing the former set (first row) with the present set. Further, the acquired first event ID and the acquired second event ID are transmitted to the second computation interim result retaining unit 6000.

The second computation interim result retaining unit 3000 tries to acquire the first event determination result “A” and the first event time “ts”, on the basis of the value of the first event ID “event_id_{—}1” (0). However, there is no data in the zero-th address in the memory 3101. Therefore, the second computation interim result retaining unit 6000 transmits “0” as the value of the first event determination result “A”, and invalid value “n/a” as the first event time respectively to the time-series computation processing unit 4000.

The time-series computation processing unit 4000 performs predetermined computation on the basis of the first event, the first event determination result (0), and the first event time (n/a); and respectively generates the second event (0), the second event determination result “A” (1), and the second event time (9:07).

The computation interim result retaining unit 6000 respectively stores the value of the second event determination result “A” (1) and the value of the second event time (9:07) in the first address in the memory 3101, on the basis of the value of the second event ID “event_id_{—}2” (1).

In the second example, when the event type whose location “Area” is 2F appears for the first time, second event ID search unit associates the location “Area” with a new event ID. Therefore, it is possible to retain a computation interim result in preparation for arrival of a next event, even when the second computation interim result retaining unit 3000 does not retain the computation interim result of an event sequence whose location “Area” is 2F.

As described above, the present invention has been described referring to the foregoing exemplary embodiments and examples. The present invention, however, is not limited to the foregoing exemplary embodiments and examples. It is possible to add various modifications, comprehensible to a person skilled in the art, to the configuration and the details of the present invention. Further, the present invention may include combination of part of or all of the configurations according to the exemplary embodiments and examples as necessary.

Part of or all of the exemplary embodiments and examples may be described as the following Supplemental Notes. The present invention, however, is not limited to the following configurations.

[Supplemental Note 1] A computation device, including: an event identification unit receiving a first event and outputting an event ID associated with an event type;

a computation interim result retaining unit receiving the event ID, and outputting a first computation interim result associated with the event ID; and

a time-series computation processing unit receiving the first event and the first computation interim result, performing computation processing, and outputting a second event and a second computation interim result,

wherein the computation interim result retaining unit receives the second computation interim result, and retains the second computation interim result and the event ID in association with each other.

[Supplemental Note 2] A computation device, including:

an event identification unit receiving a first event, outputting a first event ID associated with an event type, newly generating a second event ID, outputting the second event ID, and retaining the event type and the second event ID in association with each other;

a computation interim result retaining unit receiving the first event ID, and outputting a first computation interim result associated with the first event ID; and

a time-series computation processing unit receiving the first event and the first computation interim result, performing computation processing, and outputting a second event and a second computation interim result,

wherein the computation interim result retaining unit receives the second computation interim result and the second event ID, and retains the second computation interim result and the second event ID in association with each other.

[Supplemental Note 3] The computation device according to Supplemental Note 1 or 2, wherein

the computation processing is computation processing by a regular expression using a function as an element.

[Supplemental Note 4] A computation method for use in a computation device provided with an event identification unit, a computation interim result retaining unit, and a time-series computation processing unit, wherein

the event identification unit receives a first event and outputs an event ID associated with an event type,

the computation interim result retaining unit receives the event ID and outputs a first computation interim result associated with the event ID,

the time-series computation processing unit receives the first event and the first computation interim result, performs computation processing, and outputs a second event and a second computation interim result, and

the computation interim result retaining unit receives the second computation interim result, and retains the second computation interim result and the event ID in association with each other.

[Supplemental Note 5] A computation method for use in a computation device provided with an event identification unit, a computation interim result retaining unit, and a time-series computation processing unit, wherein

the event identification unit receives a first event, outputs a first event ID associated with an event type, newly generates a second event ID, outputs the second event ID, and retaining the event type and the second event ID in association with each other,

the computation interim result retaining unit receives the first event ID and outputs a first computation interim result associated with the first event ID,

the time-series computation processing unit receives the first event and the first computation interim result, performs computation processing, and outputs a second event and a second computation interim result, and

the computation interim result retaining unit receives the second computation interim result and the second event ID, and retains the second computation interim result and the second event ID in association with each other.

[Supplemental Note 6] The computation method according to Supplemental Note 4 or 5, wherein

the computation processing is computation processing by a regular expression using a function as an element.

[Supplemental Note 7] A computation program to allow a computer to function as event identification unit, computation interim result retaining unit, and time-series computation processing unit, wherein

the event identification unit receives a first event and outputs an event ID associated with an event type,

the computation interim result retaining unit receives the event ID and outputs a first computation interim result associated with the event ID,

the time-series computation processing unit receives the first event and the first computation interim result, performs computation processing, and outputs a second event and a second computation interim result, and

the computation interim result retaining unit receives the second computation interim result, and retains the second computation interim result and the event ID in association with each other.

[Supplemental Note 8] A computation program to allow a computer to function as event identification unit, computation interim result retaining unit, and time-series computation processing unit, wherein

the event identification unit receives a first event, outputs a first event ID associated with an event type, newly generates a second event ID, outputs the second event ID, and retaining the event type and the second event ID in association with each other,

the computation interim result retaining unit receives the first event ID and outputs a first computation interim result associated with the first event ID,

the time-series computation processing unit receives the first event and the first computation interim result, performs computation processing, and outputs a second event and a second computation interim result, and

the computation interim result retaining unit receives the second computation interim result and the second event ID, and retains the second computation interim result and the second event ID in association with each other.

[Supplemental Note 9] The computation program according to Supplemental Note 7 or 8, wherein

the computation processing is computation processing by a regular expression using a function as an element.

This application is based upon and claims the benefit of priority from Japanese Patent Application No. 2012-059262, filed on Mar. 15, 2012, the disclosure of which is incorporated herein in its entirety by reference.

### INDUSTRIAL APPLICABILITY

The present invention is applicable for use in processing real-time information (event sequence) from a sensor or a terminal. In particular, the present invention is applicable for use in classifying events of an event sequence to be transmitted from multitudes of sensors or multitudes of terminals for each individual sensor, and performing predetermined processing for each classified event. Further, the present invention is applicable for use in classifying sensors on the basis as to whether each sensor belongs to a predetermined set (such as a sensor disposed in each household, a sensor disposed in each building, and a sensor disposed in each floor of the building), and performing predetermined processing for each classified set.

### REFERENCE SIGNS LIST

100, 200 Computation device
1000 First event
1100 Second event
1001, 1002 Example of first event
1101, 1102 Example of second event
2000 Event identification unit
2001 Event ID
2101 Search key extraction unit
2201 Event ID search unit
3000 Computation interim result retaining unit
3001 First computation interim result
3002 Second computation interim result
3101 Memory
3201 Memory read control unit
3301 Memory write control unit
4000 Time-series computation processing unit
4100 Time-series computation processing calculation unit
4102A, 4102B Time-series computation processing calculation unit
4103A, 4103B Logic circuit
4200 First computation result retaining unit
4201A, 4201B, 4201C Register
4202A, 4202B, 4202C Register
4300 Second computation result retaining unit
4301A, 4301B, 4301C Register
4302A, 4302B, 4302C Register
5000 Second event identification unit
5001 First event ID
5002 Second event ID
5101 Second search key extraction unit
5201 Second event ID search unit
6000 Second computation interim result retaining unit

1. A computation device, comprising:
an event identification unit receiving a first event and outputting an event ID associated with an event type;
a computation interim result retaining unit receiving the event ID, and outputting a first computation interim result associated with the event ID; and
a time-series computation processing unit receiving the first event and the first computation interim result, performing computation processing, and outputting a second event and a second computation interim result,
wherein the computation interim result retaining unit receives the second computation interim result, and retains the second computation interim result and the event ID in association with each other.

2. (canceled)

3. The computation device according to claim 1, wherein
the computation processing is computation processing by a regular expression using a function as an element.

4. A computation method for use in a computation device provided with an event identification unit, a computation interim result retaining unit, and a time-series computation processing unit, wherein
the event identification unit receives a first event and outputs an event ID associated with an event type,
the computation interim result retaining unit receives the event ID and outputs a first computation interim result associated with the event ID,
the time-series computation processing unit receives the first event and the first computation interim result, performs computation processing, and outputs a second event and a second computation interim result, and
the computation interim result retaining unit receives the second computation interim result, and retains the second computation interim result and the event ID in association with each other.

5. (canceled)

6. The computation method according to claim 4, wherein
the computation processing is computation processing by a regular expression using a function as an element.

7. A non-transitory storage medium for recording a computation program to allow a computer to function as event identification means, computation interim result retaining means, and time-series computation processing means, wherein
the event identification means receives a first event and outputs an event ID associated with an event type,
the computation interim result retaining means receives the event ID and outputs a first computation interim result associated with the event ID,
the time-series computation processing means receives the first event and the first computation interim result, performs computation processing, and outputs a second event and a second computation interim result, and
the computation interim result retaining means receives the second computation interim result, and retains the second computation interim result and the event ID in association with each other.

8. (canceled)

9. The non-transitory storage medium according to claim 7, wherein
the computation processing is computation processing by a regular expression using a function as an element.
